(19) United States
(12) Patent Application Publication
(10) Pub. No.: US 2006/0159050 A1
(43) Pub. Date: Jul. 20, 2006

(54) System and method for handover in a wireless communication system

(75) Inventors: Hyun-Ok Kim, Osan-si (KR); Young-Seok Kim, Seongnam-si (KR); Seo-Won Kwon, Seoul (KR); Young-Jun Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Suwon-si (KR)

(21) Appl. No.: 11/336,675

(22) Filed: Jan. 20, 2006

(30) Foreign Application Priority Data
Jan. 20, 2005 (KR) 2005-5552

(51) Int. Cl. H04Q 7/00; H04Q 7/24

(52) U.S. Cl. 370/331; 370/338

(57) ABSTRACT

A method is provided for transmitting data during handover of a mobile node in a wireless communication system. Upon receiving a handover request from a particular mobile node, a multicast router creates a multicast tree depending on a multicast address of the mobile node, and transmits data to the mobile node in a multicast mode using the multicast tree.

### PRIORITY

This application claims the benefit under 35 U.S.C. § 119(a) of an application entitled “System and Method for Handover in a Wireless Communication System” filed in the Korean Intellectual Property Office on Jan. 20, 2005 and assigned Serial No. 2005-5552, the entire contents of which are hereby incorporated by reference.

### BACKGROUND OF THE INVENTION

1. Field of the Invention

The present invention relates generally to a wireless communication system, and in particular, to a handover system and method for reducing a delay time due to data transmission and minimizing a data loss rate during handover in a mobile network system.

2. Description of the Related Art

In general, transmission schemes for the Internet are classified into a unicast transmission scheme, broadcast transmission scheme and a multicast transmission scheme based on the number of senders and recipients participating in the transmission. In the unicast transmission scheme, one sender transmits data to one recipient, and the Internet applications all use the unicast transmission scheme. In the broadcast transmission scheme, one sender transmits data to all recipients in the same sub-network. In the multicast transmission scheme, one or more senders transmit data to one or more recipients, and the multicast transmission scheme is used in, for example, an Internet video conference.

To transmit the same data to a plurality of recipients for group communication using the unicast transmission scheme, it is necessary to provide multiple transmissions of a transmission data packet to each of the recipients several times. This method reduces network efficiency due to the repeated transmission of the same packet. In addition, an increase in the number of recipients increases the problem.

However, if the multicast transmission is supported, the sender can transmit a message to several recipients at a time, thereby minimizing a waste of network resources due to the repeated transmission of the data. A difference between the multicast transmission and the general unicast Internet application consists mainly in the transmission packet.

The multicast transmission scheme will now be described in more detail below.

Generally, in an Internet application program based on Transmission Control Protocol (TCP)/Internet Protocol (IP), a sender for transmitting data marks an Internet address of a recipient for receiving the data in a header of a transmission packet before transmitting the packet. However, for the multicast transmission, the sender marks an address of a group joined by recipients, instead of an address of the recipient, in the header before transmitting the packet. A D-class IP address (ranging from 224.0.0.0 to 239.255.255.255) is used for the group address for the multicast transmission. The D-class IP address represents the group address rather than an address indicating an actual host, like A, B, and C-class IP addresses representing individual Internet hosts all over the world. In addition, a recipient receiving a transmitted multicast packet having the group address determines whether to accept the packet by determining if the recipient itself belongs to a group of the packet.

However, most of the current Internet routers support only the unicast transmission. Therefore, to transmit the multicast packet, the sender transmits an encapsulated packet using the so-called tunneling concept between multicast routers (MRs). The term “encapsulation” as used herein refers to a technique for temporarily reassigning an address of an IP datagram in the course of transmitting data to a destination. That is, the encapsulation technique adds IP addresses of both ends of a tunnel established between multicast routers to a data packet header with a multicast address, before routing. In this manner, the data packet, when it passes through the general routers not supporting the multicast transmission, can be finally transmitted to a terminal of the tunnel after being routed in the conventional unicast packet transmission method.

Commonly, in the mobile network, an access router (AR) refers to an access point (AP) including a function of a router. In the following description, therefore, it will be assumed that the access point includes a function of a router.

A mobile node (MN) currently receiving a service from a particular access router can perform handover to an adjacent access router, and generally, a delay and a data loss occur in the handover process. A handover operation in the conventional mobile network will now be described below.

A configuration of a conventional mobile network system and a conventional handover process in the system will now be described with reference to the accompanying drawing.

FIG. 1 is a diagram illustrating a configuration of a conventional mobile network system.

Referring to FIG. 1, a mobile client that switches a connection point from one subnet, for example, one access router (AR), to another subnet, includes a mobile node (MN) 110 includes a Mobile IP function implemented in a TCP/IP stack and of a Dynamic Host Configuration Protocol (DHCP) function, a plurality of access routers 121 through 129 for providing a service to the mobile node 110, and a plurality of routers 131 through 135 for managing a predetermined group for each of the access routers 121 through 129.

As illustrated in FIG. 1, it is assumed that the mobile node (MN) 110 is currently receiving a service from the access router AR2 123. The mobile node 110, while receiving data from the access router AR2 123, can move to the access router AR3 125 and then receive data from the access router AR3 125.

The mobile node 110 follows the following procedure, while moving to the access router AR3 125. The mobile node 110 first disconnects a connection with the access router AR2 123, and makes a connection to the access router AR3 125 after moving to the access router AR3 125. These processes are referred to as a handover. According to the conventional technology, a handover delay time occurs in the handover process. The handover delay will now be described with reference to the system configuration of FIG. 1.

The access router currently providing a service to the mobile node 110 will be referred to as a “Serving AR,” and it will be assumed in FIG. 1 that the access router AR2 123 is a Serving AR. In addition, an access router that will provide a service to the mobile node 110 after the mobile node 110 has moved through the handover process will be referred to as a “Target AR,” and it will be assumed in FIG. 1 that the access router AR3 125 is a Target AR. A delay occurs for the interval, during in which the mobile node 110 disconnects a connection with the AR2 123 which is a serving AR, and then can receive a service again in a service area of the AR3 125 which is a Target AR, i.e., for an interval in which handover is completely performed, and the delay time caused by the handover is called a “handover delay.”

In the conventional technology, a handover delay occurs due to the handover. A protocol supporting the mobile network system includes a Mobile IP and a DHCP, and a description will now be made of a handover delay occurring when each of the protocols is used.

The DHCP is a protocol supporting the mobile network. Commonly, in the Internet TCP/IP protocol, each client system, for example, a computer should have a unique IP address to access the Internet, and the DHCP is used to allocate the unique IP address used for the Internet access. The DHCP is a protocol for a scheme in which a DHCP server automatically allocates a basic setup for various TCP/IP protocols as well as an IP address to individual clients, and the DHCP provides a limited dynamic resource sharing environment in a mobile environment.

If the DHCP is used in FIG. 1, the mobile node 110 can resume communication only when it is allocated a new IP address from a DHCP server after performing the handover. In this case, a handover delay occurs for an interval in which the mobile node 110 disconnects a previous connection and is allocated a new IP address from the DHCP server after performing handover to an area serviced by a new access router.

The Mobile IP is a standard protocol for supporting IP mobility that enables a mobile node to access the Internet even without a change in the IP address. If the Mobile IP is used in FIG. 1, the access router AR3 125 serves as a foreign agent (FA) and allocates a Care-of-Address (CoA) to the mobile node 110 that has moved thereto. In this case, a handover delay occurs for an interval in which the mobile node 110 moves to a new network and is allocated a CoA from the access router AR3 125.

The foregoing handover delay causes a mobile node receiving transmitted data traffic to suffer data loss, and also causes a drop in the service for a real-time service such as a Voice over IP (VoIP) service. That is, in the conventional mobile network, a mobile node has a handover delay until it connects a new service and the handover delay causes the fatal problems of the data loss and the service drop.

### SUMMARY OF THE INVENTION

It is, therefore, an object of the present invention to provide a handover method for reducing a handover delay time and minimizing a data loss rate due to handover of a mobile node in a mobile network.

It is another object of the present invention to provide a multicast-based handover method for minimizing a handover delay and a data loss rate by transmitting data using a multicast tree during handover of a mobile node in a mobile network.

It is further another object of the present invention to provide a method for reducing overhead due to multicast transmission during multicast-based handover in a mobile network.

It is yet another object of the present invention to provide a method for creating a multicast tree using information on a geometrically adjacent access router to reduce overhead due to multicast transmission.

It is still another object of the present invention to provide a multicast-based handover method for reducing overhead due to multicast transmission and reducing a waste of a wire/wireless bandwidth through a multicast tree created using information on a geometrically adjacent access router.

It is still another object of the present invention to provide a method for creating a multicast tree using a neighbor table including information on a geometrically adjacent access router.

According to one aspect of the present invention, there is provided a method for transmitting data during handover of a mobile node in a wireless communication system. The method includes upon receiving a handover request from a particular mobile node, creating by a multicast router a multicast tree based on a multicast address of the mobile node; and transmitting data to the mobile node in a multicast mode using the multicast tree.

According to another aspect of the present invention, there is provided a handover method of a mobile node in a wireless communication system. The method includes periodically measuring, by the mobile node, strength of a signal from a serving access router to which the mobile node is currently connected, and transmitting a handover initiation message to the serving access router upon determining a need to perform handover based on the measurement; after transmitting the handover initiation message, performing handover to a target access router and performing a registration process; and after completion of the registration process, transmitting to the target access router a handover complete message including its own multicast address.

According to further another aspect of the present invention, there is provided a method for transmitting data during handover in a wireless communication system. The method includes upon receiving a handover initiation message from a mobile node, transmitting by an access router to a multicast router connected thereto the received handover initiation message; upon receiving a multicast initiation request message from the multicast router in response to the handover initiation message, transmitting to the multicast router; a multicast initiation reply message and if data transmission is performed from the multicast router to a multicast address using the multicast tree, transmitting data to the mobile node in a multicast mode.

According to yet another aspect of the present invention, there is provided a method for transmitting data in a wireless communication system. The method includes upon determining a need to perform a handover, transmitting to a multicast router via a serving access router by a mobile node a handover initiation message; upon receiving the handover initiation message, searching by the multicast router a neighbor table to detect information on neighbor access routers geometrically neighboring the serving access router, and transmitting to detected access routers and the serving access router; a multicast initiation request messages; upon receiving the multicast initiation request message, transmitting by the access routers to the multicast router a multicast initiation reply message; and upon receiving the multicast initiation reply message, creating by the multicast router a multicast tree using a multicast address of the mobile node and transmitting data targeting the mobile node using the multicast address as a destination address.

According to still another aspect of the present invention, there is provided a network system for transmitting data in a wireless communication system. The network system includes a mobile node for transmitting a handover initiation message including a multicast address according to whether to perform handover, and after completion of handover, transmitting a handover complete message via an access router to which the mobile node has performed handover; a multicast router for receiving the handover initiation message from the mobile node, searching a neighbor table for information on a serving access router that is currently providing a service to the mobile node and on neighbor access routers geometrically neighboring the serving access router, transmitting to the detected neighbor access routers and the serving access router a multicast initiation request message including a multicast address, and upon receiving a reply to the multicast initiation request message, creating a multicast tree using the multicast address of the mobile node, and transmitting data targeting the mobile node using the multicast address as a destination address; and at least two access routers for providing a service to the mobile node, receiving a multicast initiation request message from the multicast router, and transmitting a multicast initiation reply message in response thereto.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a conventional mobile network system;

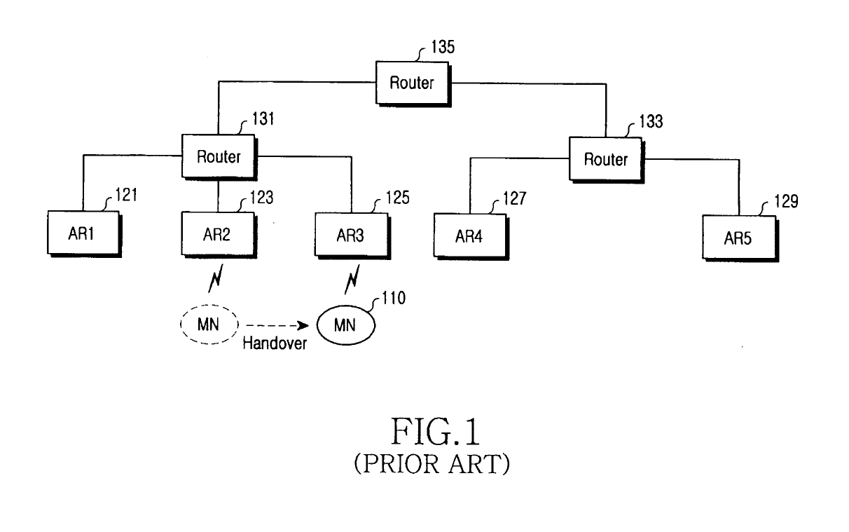

FIG. 2 is a flowchart illustrating a handover procedure using a multicast tree according to an embodiment of the present invention;

FIG. 3 is a diagram of a mobile network system and an exemplary handover operation in a multicast router according to an embodiment of the present invention;

FIGS. 4A and 4B are diagrams illustrating an exemplary method for transmitting data during handover in one multicast router according to an embodiment of the present invention;

FIG. 5 is a signaling diagram illustrating a handover procedure according to an embodiment of the present invention;

FIG. 6 is a diagram illustrating a configuration of a mobile network system and an exemplary handover operation in a multicast router according to an embodiment of the present invention; and

FIGS. 7A and 7B are diagrams illustrating an exemplary method for transmitting data during handover to a different multicast router according to an embodiment of the present invention.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

Before a detailed description of the present invention is given, it should be noted that in a mobile network system, the term “multicast” refers to a technique for transmitting data to hosts, each including a set of multicast group members. The multicast scheme has been proposed to provide a one-to-many (or point-to-multipoint) communication pattern, thereby improving bandwidth utilization through resource sharing, and reducing processing overhead of hosts and routers.

The present invention proposes a handover scheme for allowing a mobile node (MN) to create a multicast tree and transmit data using the multicast tree in performing handover in the mobile network, thereby reducing a handover delay time and minimizing a data loss rate. In order to assist the handover scheme, the present invention further proposes a method for creating the multicast tree using a neighbor table containing information on a geometrically adjacent access router (AR). To this end, the present invention further proposes functional procedures that should be performed in a multicast router (MR), an access router (AR) and a mobile node.

An embodiment of the present invention proposes a handover method in which a mobile node performs handover from a serving access router (Serving AR) from which it is receiving a service to a new access router (Target AR) in a mobile network. The Serving AR receives a service from a multicast router (MR) located in its upper node, and creates a multicast tree that defines neighbor access routers (Neighbor ARs) geometrically neighboring the Serving AR as Child nodes. The Serving AR allows the mobile node to transmit data up to the completion of its handover, using the created multicast tree.

In addition, an embodiment of the present invention assumes that the multicast router uses information on the Neighbor ARs in creating the multicast tree, and proposes a neighbor table that contains the information on the Neighbor ARs.

Compared with the handover scheme, for example, Mobile IP and DHCP, in the conventional mobile network, the method proposed by the present invention can reduce a handover delay time and minimize a data loss rate. In addition, the present invention creates a multicast tree using information of the Neighbor ARs, making it possible to perform multicast transmission to a limited area. This contributes to a reduction in the waste of wire/wireless bandwidth.

One embodiment of the present invention includes a mobile node (MN), a Serving AR, a Target AR, Neighbor ARs, a multicast router (MR), and a neighbor table. A detailed description of the configuration will be made later.

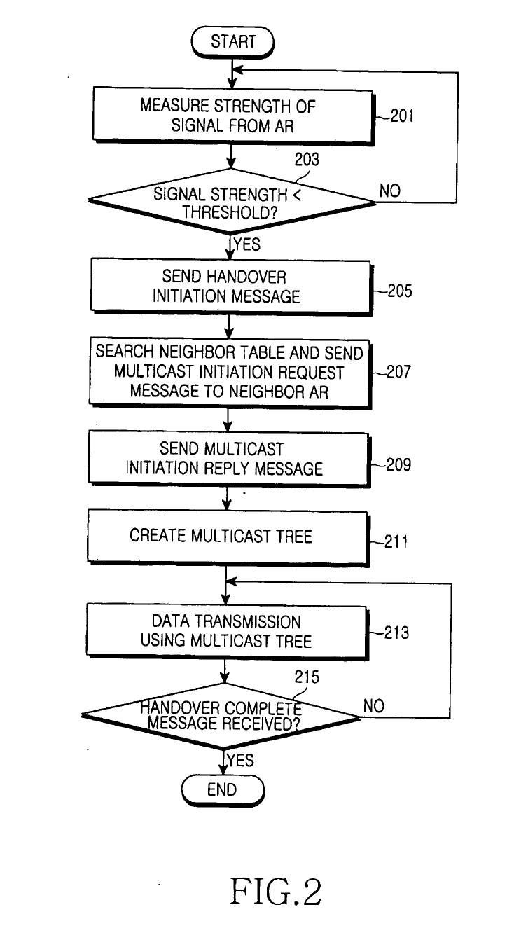

FIG. 2 is a flowchart illustrating a handover procedure using a multicast tree according to an embodiment of the present invention.

Referring to FIG. 2, a mobile node first starts its basic operation. In this case, if the mobile node is receiving a service from an access router, i.e., a Serving AR, the mobile node is allocated a multicast address to be used later during handover from the Serving AR and stores the allocated multicast address.

Thereafter, the mobile node periodically measures in step 201 the strength of a signal from the Serving AR and determines whether to perform handover in step 203. The signal strength is inversely proportional to a square of a distance between the mobile node and the Serving AR. Therefore, a decrease in the signal strength means an increase in the distance between the mobile node and the Serving AR from which the mobile node is receiving a service. The mobile node determines whether to perform handover by comparing the measured signal strength with a threshold preset according to a system condition.

If the measured signal strength is less than the threshold, i.e., if the mobile node has moved to a boundary or an overlapping point between the Serving AR and a Target AR to which it will move, the mobile node transmits in step 205 a Handover Initiation message to the Serving AR. In this case, the mobile node transmits the Handover Initiation message together with a multicast address for a multicast tree. Upon receiving the Handover Initiation message, the Serving AR forwards the received Handover Initiation message to a multicast router located in its upper node.

Upon receiving the Handover Initiation message, the multicast router searches its neighbor table. In the neighbor table, access routers included in a service area of the multicast router are mapped to information on their associated Neighbor ARs. Through the search of the neighbor table, the multicast router reads information on the Neighbor ARs geometrically neighboring the Serving AR that transmitted the Handover Initiation message. Subsequently, the multicast router transmits in step 207 a Multicast Initiation Request message to the access routers corresponding to the read information and the Serving AR. The Multicast Initiation Request message also includes the multicast address included in the Handover Initiation message received from the mobile node.

Upon receiving the Multicast Initiation Request message from the multicast router, the Serving AR that transmitted the Handover Initiation message, and the Neighbor ARs neighboring the Serving AR transmit in step 209 a Multicast Initiation Reply message to the multicast router in response to the received Multicast Initiation Request message. In this case, the Serving AR and the Neighbor ARs set the multicast address included in the Multicast Initiation Request message as their multicast group addresses.

Thereafter, if the Multicast Initiation Reply message is received from the access routers, the multicast router creates a multicast tree in step 211. Subsequently, the multicast router performs in step 213 data transmission to the multicast address for the next data traffic using the created multicast tree. The transmission using the multicast tree continues until the mobile node completes the handover.

If the mobile node completes the handover in step 215, the mobile node transmits a Handover Complete message to the Target AR to which the mobile node has newly moved. Upon receiving the Handover Complete message, the Target AR stops the multicast transmission and transmits the Handover Complete message to the multicast router located in its upper node for completion of the multicast transmission. Upon receiving the Handover Complete message, the multicast router switches from the previous multicast transmission mode back to the general unicast transmission mode, and transmits the next data traffic to the mobile node on a unicast basis, completing the handover procedure.

In the foregoing multicast data transmission according to an embodiment of the present invention, data traffic is delivered from the multicast router to the mobile node via the Neighbor ARs geometrically neighboring the Serving AR in the course of the handover process.

In this case, the multicast router maintains the multicast tree including the Serving AR and the Neighbor ARs. Thereafter, if any data traffic targeting the mobile node is received, the multicast router adds thereto a header defining a destination address of the data as a multicast address, and transmits the data using the multicast tree. Preferably, the multicast address is an IP address.

Upon receiving the data transmitted from the multicast router, the Neighbor ARs convert the multicast address (IP address) included in the destination address into a Medium Access Control (MAC) address using an Address Resolution Protocol (ARP). The MAC address represents hardware address such as, for example, an Ethernet address.

Once the Neighbor ARs are aware of the hardware address of the corresponding mobile node through the foregoing procedure, the Neighbor ARs perform data transmission using the hardware address. Finally, upon receiving the data with the multicast address, the mobile node removes from the received data the header added by the multicast router.

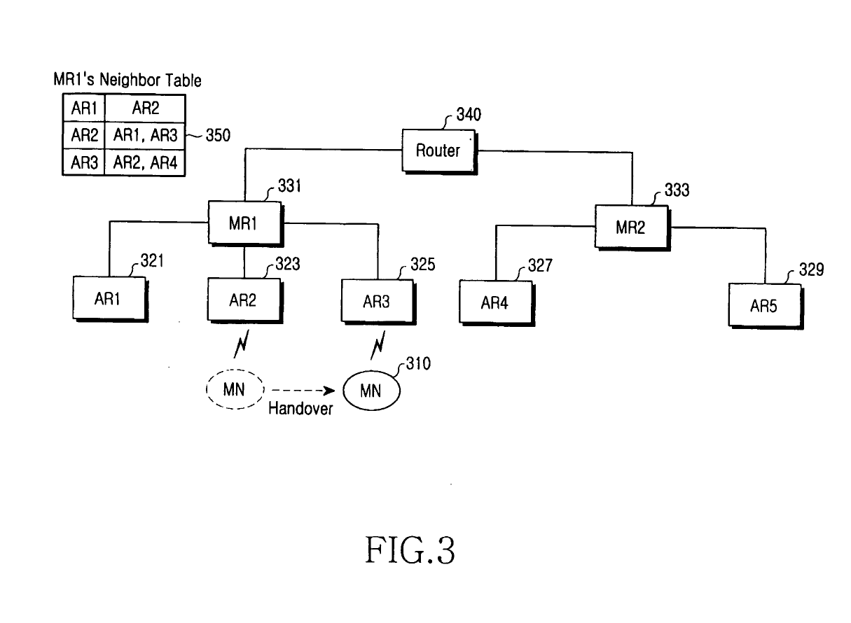

The description will now be made with reference to FIG. 3. It is assumed in FIG. 3 that data is transmitted to access routers AR2 323 and AR3 325 with a multicast address, and a mobile node (MN) 310 is connected to the access router AR3 325 through a handover process. When the access router AR3 325 performs the ARP, the mobile node MN 310 replies thereto, enabling data transmission. When the access router AR2 323 performs the ARP with the multicast address, received data is discarded in the access router AR2 323 because there is no mobile node replying thereto.

FIG. 3 is a diagram for a description of a configuration of a mobile network system and an exemplary handover operation in a multicast router according to an embodiment of the present invention.

Referring to FIG. 3, a mobile network proposed by an embodiment of the present invention includes a mobile node MN 310, a plurality of access routers AR1 321 through AR5 329 for providing a service to the mobile node MN 310, a plurality of multicast routers MR1 331 through MR2 333 for managing the access routers, and an upper-node router 340 for managing the multicast routers.

The access routers 321 through 329 can be divided into a Serving Access Router (Serving AR), for example, the AR2 323, that is currently providing a service to the mobile node MN 310, a Target Access Router (Target AR), for example, the AR3 325, that provides a service to the mobile node MN 310 that has newly moved thereto through handover, and Neighbor Access Routers (Neighbor ARs), for example, the AR1 321 and the AR3 325, that can latently be a Target AR and geometrically neighbors the AR2 323 which is the Serving AR.

The multicast routers MR1 331 and MR2 333 each create a multicast tree and perform multicast transmission during handover of the mobile node MN 310. The multicast routers MR1 331 and MR2 333 each include a neighbor table to create the multicast tree. That is, the multicast routers MR1 331 and MR2 333 each include a neighbor table for storing information on geometrically adjacent access routers between the access routers 321 through 329, for example, a neighbor table like a neighbor table 350 of the multicast router MR1 331, shown in FIG. 3.

As illustrated in FIG. 3, the multicast router MR1 331 maintains the neighbor table 350 for the access routers AR1 321, AR2 323 and AR3 325 located in its lower nodes.

The neighbor table 350 can be created in any method regardless of operation of the present invention. For example, the neighbor table can be created using either a method of inputting previously created values by a manager or a method of dynamically updating the neighbor table. That is, it is preferable to use the dynamic update method for a network condition in which the network configuration is subject to frequent change, and use the previously created value inputting method for a network condition in which the network configuration is not subject to frequent change. Preferably, however, the neighbor table 350 is created such that it includes information in the form of [access router: list of geometrically adjacent access routers] as shown in Table 1.

TABLE 1

| | |
|---|---|
| AR1 | AR2 |
| AR2 | AR1, AR3 |
| AR3 | AR2, AR4 |

Table 1 shows an exemplary neighbor table for the mobile network of FIG. 3. The neighbor table will be described with reference to FIG. 3. Because the access routers geometrically neighboring the access router AR2 323 include the access routers AR1 321 and AR3 325, this is expressed as [AR2: AR1, AR3] in the neighbor table 350 of the multicast router MR1 331. Therefore, when the mobile node MN 310 performs handover from the access router AR2 323 to the access router AR3 325, the multicast router MR1 331 searches its neighbor table 350 for information on the access router AR2 323, and uses it for creating a multicast tree. An example of this will be described with reference to the accompanying drawings.

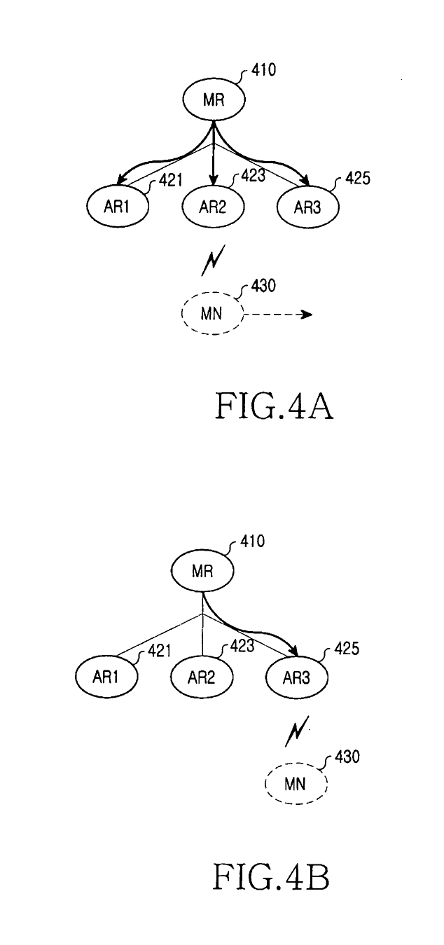

FIGS. 4A and 4B are diagrams illustrating an exemplary method for transmitting data during handover in the multicast router of FIG. 3 according to an embodiment of the present invention. Specifically, FIG. 4A illustrates an exemplary multicast transmission process during handover, and FIG. 4B illustrates an exemplary unicast transmission process after completion of the handover.

FIG. 4A illustrates an exemplary operation in which the multicast router MR1 331 of FIG. 3 performs handover using the information searched from the neighbor table 350. That is, FIG. 4A illustrates a data transmission process in which, for data transmission, a multicast router MR 410 uses a multicast tree created by defining access routers AR1 421, AR2 423 and AR3 425 as its Child nodes and a multicast tree created during handover of a mobile node MN 430, based on the information included in the neighbor table 350.

As illustrated in FIG. 4A, if any data traffic targeting the mobile node MN 430 is received, the multicast router 410 adds a header to the data traffic defining a destination address of the data as a multicast address, and transmits the data using the multicast tree on a multicast basis. Then the mobile node MN 430 can continue to receive data traffic using the multicast address even during handover from the access router AR2 423 to the access router AR3 425.

FIG. 4B illustrates an exemplary operation in which the mobile node MN 310 of FIG. 3 switches back to the unicast transmission mode and receives data traffic after completion of the handover. That is, FIG. 4B illustrates a data traffic reception process in which the mobile node MN 430 receives data traffic after completion of the handover from a Serving AR to a Target AR.

As illustrated in FIG. 4B, the mobile node 430 receives data on a multicast basis during handover as shown in FIG. 4A, and receives data on a unicast basis after completion of the handover, thereby reducing a data loss rate and a handover delay, which may occur during the handover.

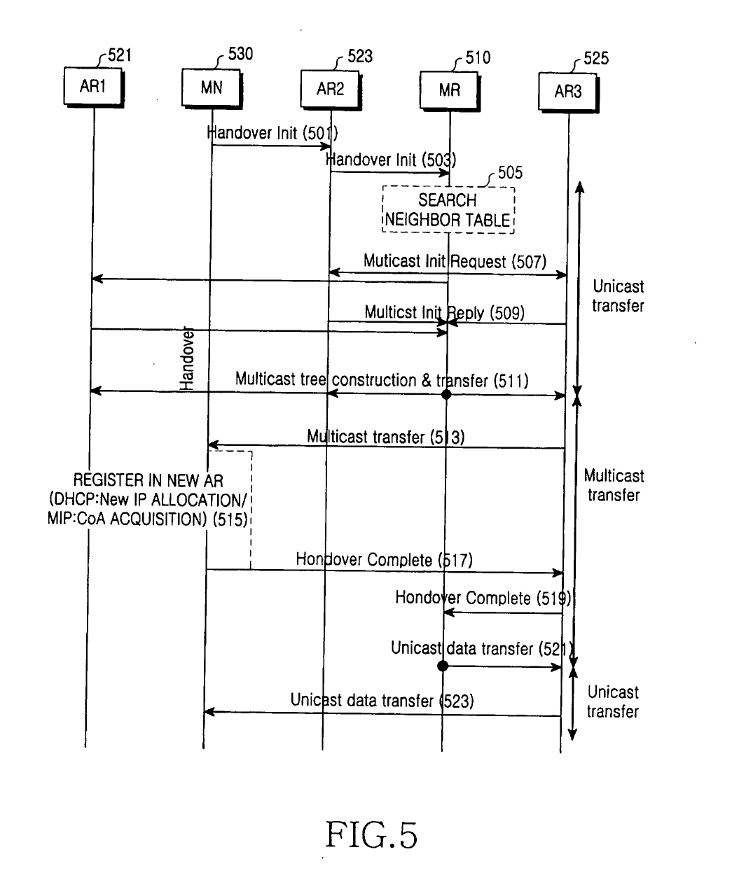

FIG. 5 is a signaling diagram illustrating a handover procedure according to an embodiment of the present invention.

It is assumed in FIG. 5 that a mobile node MN 530 is currently receiving a service from an access router AR2 523, which serves as a Serving AR, and will move to an access router AR3 525, which serves as a Target AR, to which it will perform handover.

As illustrated in FIG. 5, the mobile node MN 530 starts a handover while receiving a service from the access router AR2 523. The mobile node MN 530 starts the handover if the measured strength of a signal from its Serving AR is less than a threshold.

The mobile node MN 530, as it starts the handover, transmits in step 501 a Handover Initiation message to the AR2 523, which is a Serving AR. The Handover Initiation message includes a multicast address (for example, 239.0.0.1) that the mobile node MN 530 was previously allocated from the Serving AR 523 and has stored therein.

Upon receiving the Handover Initiation message from the mobile node MN 530, the AR2 523 forwards in step 503 the received Handover Initiation message to a multicast router MR 510 located in its upper node. The multicast router MR 510 searches in step 505 its neighbor table for neighbor information of the AR2 523 which is the Serving AR, i.e., information on access routers geometrically neighboring the AR2 523 to detect Neighbor ARs of the AR2 523 which is the Serving AR.

The multicast router MR 510 creates a multicast tree using information on the Neighbor ARs, i.e., AR1 521 and AR3 525, of the AR2 523, searched in step 505. That is, the multicast router MR 510 transmits in step 507 a Multicast Initiation Request message including a multicast address, for example, the multicast address of 239.0.0.1 transmitted by the mobile node MN 530, to the AR2 523 which is the Serving AR, and the AR1 521 and AR3 525 which are the Neighbor Ars. Then the access routers AR1 521, AR2 523 and AR3 525 each transmit in step 509 a Multicast Initiation Reply message to the multicast router MR 510 in response to the Multicast Initiation Request message.

Upon receiving the Multicast Initiation Reply message from each of the access routers 521, 523 and 525, the multicast router MR 510 creates a multicast tree in step 511 such that the multicast router MR 510 is defined as a root and the AR2 523 which is the Serving AR and the AR1 521 and AR3 525 which are the Neighbor ARs are defined as Child nodes. The multicast router MR 510, maintaining the created multicast tree information, transmits in step 513 the next data traffic to the mobile node MN 530 with the multicast address using the created multicast tree.

Thereafter, the mobile node MN 530 performs handover to a new access router, i.e., a Target AR. It is assumed in FIG. 5 that the mobile node MN 530 performs handover to the AR3 525 which is the Target AR. Therefore, the mobile node MN 530 performs handover to the AR3 525 which is the Target AR and performs a registration process in step 515. When a DHCP is used for the registration process, the mobile node MN 530 is allocated a new IP address from an undepicted DHCP server. When a Mobile IP (MIP) is used for the registration process, the mobile node MN 530 acquires Care-of-Address (CoA) from the AR3 525 which is the Target AR serving as a foreign agent (FA).

After completion of the registration process following the handover, the mobile node MN 530 transmits in step 517 a Handover Complete message including its multicast address, for example, 239.0.0.1, to the AR3 525 which is the Target AR, thereby inducing switching from the multicast transmission to the unicast transmission. Upon receiving the Handover Complete message from the mobile node MN 530, the AR3 525 which is the Target AR transmits in step 519 the received Handover Complete message to the multicast router MR 510.

If the Handover Complete message is received from the AR3 525 which is the Target AR, the multicast router MR 510 switches in step 521 the data transmission scheme from the multicast transmission scheme back to the unicast transmission scheme. After switching the data transmission scheme, the multicast router MR 510 stores the corresponding information and transmits in step 523 the data traffic to the mobile node MN 530 using the general unicast transmission scheme.

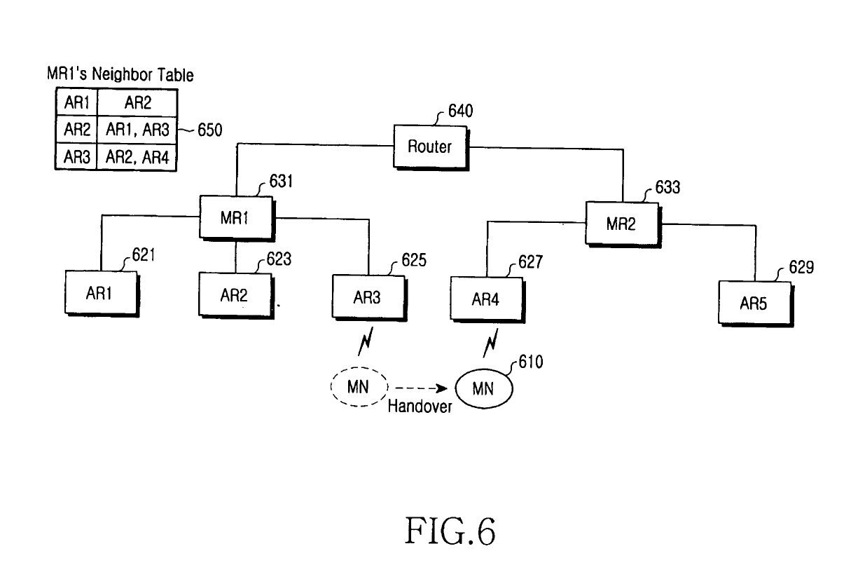

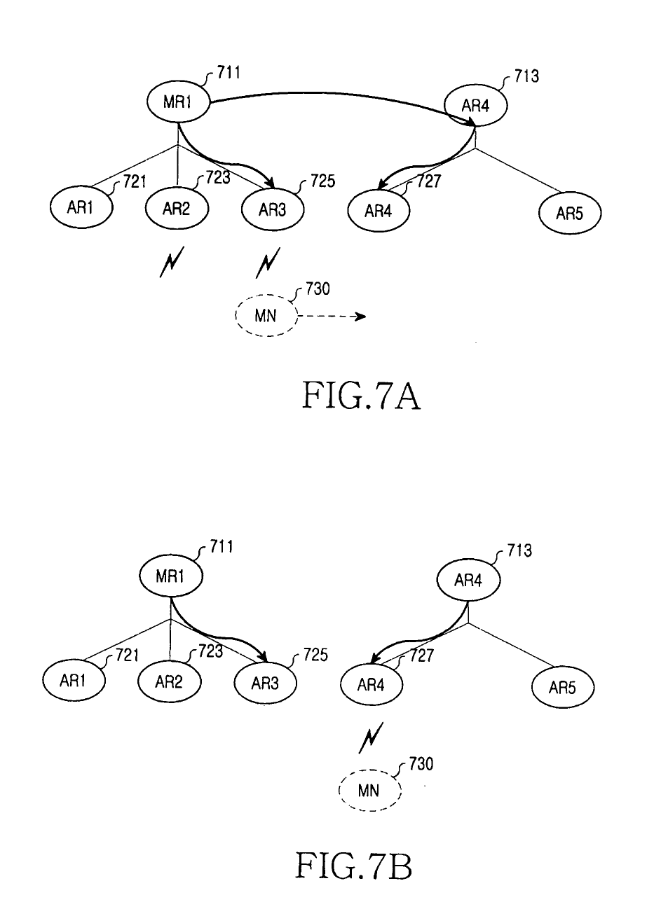

Next, with reference to FIGS. 6, 7A and 7B, a description will be made of a handover procedure between access routers located in service areas of different multicast routers during handover of the mobile node.

FIG. 6 is a diagram illustrating a configuration of a mobile network system and an exemplary handover operation in a multicast router according to an embodiment of the present invention. In particular, FIG. 6 is a diagram for a of handover process to a different multicast router.

Referring to FIG. 6, a mobile network of the present invention includes a mobile node MN 610, a plurality of access routers AR1 621 through AR5 629 for providing a service to the mobile node MN 610, a plurality of multicast routers MR1 631 through MR2 633 for managing the access routers, and an upper-node router 640 for managing the multicast routers.

In an embodiment of FIG. 6, a mobile node MN performs a handover to a different adjacent multicast router rather than its own multicast router. That is, in FIG. 6, a multicast router managing a Target AR from which the mobile node MN 610 will receive a service through handover is different from a multicast router managing a Serving AR from which the mobile node MN 610 is currently receiving a service. As shown in FIG. 6, the AR3 625 which is a Serving AR that is currently providing a service to the mobile node MN 610 belongs to the multicast router MR1 631, and the AR4 627 which is a Target AR that will provide a service to the mobile node MN 610 after handover belongs to the multicast router MR2 633.

As illustrated in FIG. 6, the multicast router MR1 631 has a neighbor table 650 for the access routers AR1 621, AR2 623 and AR3 625 located in its lower nodes. The neighbor table 650 can be created in the various methods described above. For example, in a network condition in which the network configuration is subject to frequent change, the neighbor table 650 can be created by dynamically updating the neighbor table. However, in a network condition in which the network configuration is not subject to frequent change, the neighbor table 650 can be created by inputting previously created values by a manager. Preferably, the neighbor table 650 is created such that it includes information in the form of [access router: list of geometrically adjacent access routers] as shown in Table 1.

If the mobile node MN 610 performs a handover from the AR3 625 which is the Serving AR to the AR4 627 which is the Target AR, the handover procedure is similar to the procedure performed in FIG. 3, even though the AR3 625 which is the Serving AR and the AR4 627 which is the Target AR belong different multicast routers MR1 631 and MR2 633, respectively.

More specifically, upon receiving a Handover Initiation message from the mobile node MN 610, the AR3 625 which is the Serving AR forwards the received Handover Initiation message to the multicast router MR1 631 located in its upper node, and the multicast router MR1 631 searches its neighbor table 650 for access routers geometrically neighboring the AR3 625 to detect Neighbor ARs of the AR3 625.

In FIG. 6, the Neighbor ARs of the AR3 625 include the AR2 623 and the AR4 627. That is, it is assumed in this embodiment that a list of geometrically adjacent access routers is previously included in the neighbor table. Herein, the term “search” refers to a process of acquiring information on adjacent access routers from the neighbor table previously created according to the system condition.

Subsequently, the multicast router MR1 631 transmits a Multicast Initiation Request message to the AR3 625 which is the Serving AR and the AR2 623 and the AR4 627 which are the Neighbor ARs, using information on the detected Neighbor ARs. In this case, even though the AR3 625 and the AR4 627 belong to different multicast routers MR1 631 and MR2 633, respectively, the multicast router MR1 631 has no difficulty in transmitting the Multicast Initiation Request message because it has previously stored information on the AR4 627, for example, an IP address of the AR4 627.

Although the information on the geometrically adjacent access routers, stored in the neighbor table, has been represented by AR1, AR2 and AR3 by way of example, this can also include identifiers or IP addresses of the access routers. In other words, it is preferable to use the IP addresses to reduce a delay time because it is necessary to acquire the IP addresses to transmit data even though the identifiers are used. Therefore, IP addresses of the geometrically adjacent access routers should also be previously stored. It is assumed in the present invention that the neighbor table includes IP addresses or the access routers AR1 through AR5 are mapped to their corresponding IP addresses in the neighbor table.

Upon receiving the Multicast Initiation Request message, the multicast router MR2 633 generates a multicast tree and transmits traffic data to the multicast address using the generated multicast tree in the procedure described with reference to FIG. 3. Therefore, a detailed description thereof will be omitted herein for simplicity.

FIGS. 7A and 7B are diagrams illustrating an exemplary method for transmitting data during handover to a different multicast router according to an embodiment of the present invention. Specifically, FIG. 7A illustrates an exemplary multicast transmission process during handover, and FIG. 7B illustrates an exemplary unicast transmission process after completion of the handover.

FIG. 7A illustrates a data transmission process in which for data transmission, a multicast router MR1 711 uses a multicast tree created by defining its access routers AR2 723 and AR3 725 and an AR4 727 belonging to another multicast router MR2 713 as its Child nodes and a multicast tree created during handover of a mobile node MN 730, based on the information included in the neighbor table.

As illustrated in FIG. 7A, if any data traffic targeting the mobile node MN 730 is received, the multicast router 711 adds thereto a header defining a destination address of the data as a multicast address, and transmits the data using the multicast tree on a multicast basis. Then the mobile node MN 730 can continue to receive data traffic using the multicast address even during handover from the access router AR3 725 of the multicast router MR1 711 to the access router AR4 727 of anther multicast router MR2 713.

FIG. 7B illustrates an exemplary operation in which the mobile node MN 610 of FIG. 6 switches back to the unicast transmission mode and receives data traffic after completion of the handover. That is, FIG. 7B illustrates a data traffic reception process in which the mobile node MN 730 receives data traffic using the unicast transmission scheme after completion of the handover from a Serving AR belonging to the multicast router MR1 711 to a Target AR belonging to another multicast router MR2 713.

As illustrated in FIG. 7B, the mobile node 730 receives data using the multicast transmission scheme during handover as shown in FIG. 7A, and receives data using the unicast transmission scheme after completion of the handover. In this manner, an embodiment of the present invention reduces a data loss rate and a handover delay, which may occur during the handover.

Similarly, even when the mobile node moves from the current multicast router to anther multicast router, the handover procedure proposed by an embodiment of the present invention can reduce the data loss rate and the handover delay.

As described above, for transmission of data traffic, the present invention allows a mobile node to switch its transmission mode to a multicast transmission mode using a multicast tree during handover between access routers in a mobile network. After completion of the handover, the mobile node switches its transmission mode back to the unicast transmission mode and transmits the data traffic. The adaptive switching of the data traffic transmission mode contributes to a reduction in the handover delay and the data loss rate during handover.

In order to create the multicast tree for the multicast transmission, the present invention maintains a neighbor table for storing information on the geometrically adjacent access routers to limit a range of the multicast transmission, thereby reducing a waste of bandwidth due to the multicast transmission. In addition, an embodiment of the present invention allows neighbor access routers to multicast data to a mobile node at the handover time of the mobile node, enabling seamless and fast data transmission/reception during the handover.

As can be understood from the foregoing description, a multicast-based handover method according of the present invention performs data transmission using a multicast tree when a mobile node performs a handover in the mobile network, thereby contributing to a reduction in handover delay and data loss rate.

The multicast tree is created using information on geometrically adjacent access routers to reduce overhead for multicast transmission, thus contributing to prevention of a waste of the wire/wireless bandwidth.

In addition, the adjacent access routers multicast data to a mobile node at the handover time of the mobile node, providing seamless and fast data transmission/reception during the handover.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting data during handover of a mobile node in a wireless communication system, the method comprising the steps of:
upon receiving a handover request from a mobile node, creating by a multicast router a multicast tree based on a multicast address of the mobile node; and
transmitting data to the mobile node in a multicast mode using the multicast tree.

2. The method of claim 1, further comprising the step of switching from the multicast mode to a unicast mode and transmitting data to the mobile node in the unicast mode, if handover of the mobile node is completed.

3. The method of claim 1, wherein the multicast tree is created based on a mapping table containing information about a serving access router that is currently providing a service to the mobile node and neighbor access routers geometrically neighboring the serving access router.

4. The method of claim 3, wherein the mapping table includes mapping information of the neighbor access routers neighboring each of the access router

5. The method of claim 1, wherein the multicast router creates the multicast tree such that the multicast router is defined as a root, and a serving access router and neighbor access routers are defined as child nodes based on a mapping table.

6. The method of claim 1, wherein the access routers transmit data on a multicast basis at a handover time of the mobile node.

7. The method of claim 1, further comprising the steps of:
upon receiving a handover initiation message from a mobile node, searching by the multicast router its neighbor table;
detecting information on a serving access router that is currently providing a service to the mobile node and on neighbor access routers geometrically neighboring the serving access router;
transmitting a multicast initiation request message to the detected neighbor access routers and the serving access router; and
creating a multicast tree upon receiving a multicast initiation reply message from each of the access routers in response to the multicast initiation request message.

8. The method of claim 7, further comprising the steps of:
upon receiving a handover complete message from the mobile node, switching from the multicast transmission mode to a unicast transmission mode; and
after switching to the unicast transmission mode, transmitting data to the mobile node on a unicast basis.

9. The method of claim 7, wherein the handover initiation message includes a multicast address.

10. The method of claim 7, wherein the neighbor table includes mapping information of neighbor access routers neighboring each access router.

11. The method of claim 7, wherein the multicast initiation request message includes a multicast address.

12. The method of claim 7, further comprising the step of, if any data targeting the mobile node is received after creating the multicast tree, adding to the data targeting the mobile node a header defining a destination address of the data as a multicast address and transmitting the data to access routers included in the multicast tree;
wherein upon receiving the data, the access routers convert the multicast address included in the destination address into a hardware address using an address resolution protocol and transmit data to the hardware address of the mobile node if the hardware address of the mobile node is detected through the conversion.

13. The method of claim 12, wherein the hardware address of the mobile node includes a medium access control (MAC) address.

14. A handover method of a mobile node in a wireless communication system, the method comprising the steps of:
periodically measuring, by the mobile node, strength of a signal from a serving access router to which the mobile node is currently connected, and transmitting a handover initiation message to the serving access router upon determining a need to perform handover based on the measurement;
after transmitting the handover initiation message, performing a handover to a target access router and performing a registration process; and
after completion of the registration process, transmitting to the target access router a handover complete message including its own multicast address.

15. The method of claim 14, further comprising the step of receiving by the mobile node a previously allocated multicast address used for the handover from the serving access router.

16. The method of claim 14, wherein the mobile node includes a multicast address for multicast transmission in the handover initiation message before transmission.

17. The method of claim 14, further comprising the step of receiving by the mobile node a new Internet protocol (IP) address allocated from a dynamic host configuration protocol (DHCP) server, when the mobile node uses a DHCP for the registration process.

18. The method of claim 14, further comprising the step of acquiring by the mobile node a care-of-address (CoA) from the target access router, when the mobile node uses a mobile IP for the registration process.

19. The method of claim 18, wherein if the mobile node performs the registration process using the mobile IP, the target access router serves as a foreign agent (FA) to allocate the CoA to the mobile node.

20. The method of claim 14, wherein the handover complete message includes a multicast address of the mobile node.

21. The method of claim 14, further comprising the steps of:
receiving data multicast from the target access router at a handover time of the mobile node; and
receiving data unicast from the target access router after the handover.

22. A method for transmitting data during handover in a wireless communication system, the method comprising the steps of:
upon receiving a handover initiation message from a mobile node, transmitting by an access router the received handover initiation message to a multicast router connected thereto;
upon receiving a multicast initiation request message from the multicast router in response to the handover initiation message, transmitting to the multicast router a multicast initiation reply message; and
if data transmission is performed from the multicast router to a multicast address using the multicast tree, transmitting data to the mobile node in a multicast mode.

23. The method of claim 22, wherein the handover initiation message includes a multicast address.

24. The method of claim 22, wherein the multicast initiation request message includes a multicast address.

25. The method of claim 22, further comprising the step of, upon receiving a multicast initiation request message from the multicast router, defining a multicast address included in the multicast initiation request message as its multicast group address.

26. The method of claim 22, further comprising the steps of:
upon receiving a handover complete message from the mobile node, stopping by the access router the multicast transmission to the mobile node and transmitting a handover complete message to the multicast router; and
upon receiving information indicating a change in transmission mode from the multicast router, transmitting data to the mobile node on a unicast basis.

27. A method for transmitting data in a wireless communication system, the method comprising the steps of:
upon determining a need to perform handover, transmitting by a mobile node a handover initiation message to a multicast router via a serving access router;
upon receiving the handover initiation message, searching by the multicast router a neighbor table to detect information on neighbor access routers geometrically neighboring the serving access router, and transmitting a multicast initiation request message to the detected access routers and the serving access router;
upon receiving the multicast initiation request message, transmitting by the access routers to the multicast router a multicast initiation reply message; and
upon receiving the multicast initiation reply message, creating by the multicast router a multicast tree using a multicast address of the mobile node and transmitting data targeting the mobile node using the multicast address as a destination address.

28. The method of claim 27, further comprising the steps of:
after completion of the handover to the target access router, transmitting by the mobile node to the multicast router via the target access router a handover complete message; and
upon receiving the handover complete message, stopping by the multicast router the multicast transmission to the mobile node and transmitting data targeting the mobile node in a unicast mode.

29. The method of claim 27, further comprising the step of, before performing handover, receiving by the mobile node an allocated multicast address used for performing a handover from the serving access router.

30. The method of claim 27, further comprising the step of periodically measuring, by the mobile node, strength of a signal from the serving access router to determine whether to perform handover, wherein the mobile node determines whether to perform handover by comparing the measured signal strength with a threshold based on system conditions.

31. The method of claim 27, wherein the handover initiation message includes a multicast address.

32. The method of claim 27, wherein the neighbor table includes mapping information for neighbor access routers neighboring each access routers.

33. The method of claim 27, wherein the multicast initiation request message includes a multicast address.

34. The method of claim 27, further comprising the step of transmitting, by the serving access router and the neighbor access routers, the multicast initiation reply message, and then defining a multicast group address based on the multicast address included in the multicast initiation request message.

35. The method of claim 27, wherein upon receiving the multicast initiation reply message, the multicast router creates a multicast tree such that the multicast router is defined as a root, and the serving access router and neighbor access routers for the serving access router are defined as child nodes based on the neighbor table.

36. The method of claim 27, further comprising the steps of:
if data targeting the mobile node is received after creating the multicast tree, adding to the data by the multicast router a header defining a destination address of the data as a multicast address and transmitting the data to access routers included in the multicast tree; and
upon receiving the data, converting by the access routers the multicast address included in the destination address into a hardware address using an address resolution protocol and transmitting data to the hardware address of the mobile node if the hardware address of the mobile node is detected through the conversion.

37. The method of claim 36, wherein the hardware address of the mobile node includes a medium access control (MAC) address.

38. The method of claim 36, further comprising the step of, upon receiving data with the multicast address, removing the by mobile node the header added by the multicast router.

39. The method of claim 36, further comprising the step of transmitting, by the access routers, data upon receiving from the mobile node a response to the address resolution protocol; and discarding the data upon receiving no response from the mobile node.

40. The method of claim 27, wherein the data transmission based on the multicast address continues until the handover of the mobile node is complete.

41. The method of claim 27, further comprising the step of registering by the mobile node with the target access router if the handover to the target access router is completed;
the registration step comprising the steps of:
receiving a new Internet protocol (IP) address allocated from a dynamic host configuration protocol (DHCP) server; and
acquiring a care-of-address (CoA) from the target access router.

42. A network system for transmitting data in a wireless communication system, the system comprising:
a mobile node for transmitting a handover initiation message including a multicast address if a handover is to be performed, and after completion of the handover, transmitting a handover complete message via an access router to which the mobile node has performed the handover;
a multicast router for receiving the handover initiation message from the mobile node, searching a neighbor table for information on a serving access router that is currently providing a service to the mobile node and on neighbor access routers geometrically neighboring the serving access router, transmitting a multicast initiation request message including a multicast address to the detected neighbor access routers and the serving access router, and upon receiving a reply to the multicast initiation request message, creating a multicast tree using the multicast address of the mobile node, and transmitting data targeting the mobile node using the multicast address as a destination address; and
at least two access routers for providing a service to the mobile node, receiving a multicast initiation request message from the multicast router, and transmitting a multicast initiation reply message in response thereto.

43. The network system of claim 42, wherein upon receiving a handover complete message from the mobile node, the multicast router stops the multicast transmission to the mobile node and transmits data targeting the mobile node in a unicast mode.

44. The network system of claim 41, wherein before performing handover, the mobile node receives and stores an allocated multicast address used to perform a handover from a serving access router to which the mobile node is currently connected.

45. The network system of claim 42, wherein the neighbor table includes mapping information for neighbor access routers neighboring each access router.

46. The network system of claim 42, wherein the serving access router and the neighbor access routers transmit the multicast initiation reply message, and then define a multicast group address through the multicast address included in the multicast initiation request message.

47. The network system of claim 42, wherein upon receiving the multicast initiation reply message, the multicast router creates a multicast tree such that the multicast router is defined as a root, and the serving access router and neighbor access routers for the serving access router are defined as child nodes based on the neighbor table.

48. The network system of claim 42, wherein if any data targeting the mobile node is received after creating the multicast tree, the multicast router adds a header to the data defining a destination address of the data as a multicast address and transmits the data to access routers included in the multicast tree.

49. The network system of claim 42, wherein the access routers convert the multicast address included in the destination address into a hardware address using an address resolution protocol, and transmit next data to the hardware address of the mobile node if the hardware address of the mobile node is detected through the conversion.

50. The network system of claim 49, wherein the hardware address of the mobile node includes a medium access control (MAC) address.

51. The network system of claim 42, wherein the mobile node removes the header added by the multicast router, upon receiving data with the multicast address.

52. The network system of claim 42, wherein the access routers transmit data upon receiving a response to the address resolution protocol from the mobile node, and discard the data upon receiving no response from the mobile node.

53. The network system of claim 42, wherein the mobile node performs registration with the target access router if the handover to the target access router is completed; and
wherein for the registration, the mobile nodes receives a new Internet protocol (IP) address allocated from a dynamic host configuration protocol (DHCP) server, or acquires a care-of-address (CoA) from the target access router.
